(19) United States
(12) Patent Application Publication
(10) Pub. No.: US 2025/0231515 A1
(43) Pub. Date: Jul. 17, 2025

(54) IMAGE FORMING APPARATUS

(71) Applicant: KYOCERA Document Solutions Inc., Osaka (JP)

(72) Inventors: Minoru WADA, Osaka (JP); Junichi NAKAGAWA, Osaka (JP); Hiroshi YAMAZAKI, Osaka (JP)

(73) Assignee: KYOCERA Document Solutions Inc., Osaka (JP)

(21) Appl. No.: 19/010,894

(22) Filed: Jan. 6, 2025

(30) Foreign Application Priority Data
Jan. 12, 2024 (JP) 2024-003553

(51) Int. Cl. G03G 15/00; G03G 15/01; G03G 15/08

(52) U.S. Cl. CPC G03G 15/556; G03G 15/0121; G03G 15/0189; G03G 15/0849; G03G 15/0867; G03G 15/50

(57) ABSTRACT

An image forming apparatus includes a developing device, a container, a toner supplying device, and a control portion. The developing device supplies toner to an image carrying member. The container stores the toner supplied to the developing device. The toner supplying device transports the toner in the container to the developing device to supply the toner to it. The control portion senses toner emptiness in the container by using a plurality of emptiness sensing paths and uses different emptiness sensing conditions for the plurality of emptiness sensing paths.

### INCORPORATION BY REFERENCE

This application is based on and claims the benefit of priority from Japanese Patent Application No. 2024-003553 filed on Jan. 12, 2024, the contents of which are hereby incorporated by reference.

### BACKGROUND

The present disclosure relates to an image forming apparatus.

In image forming apparatuses of an electrophotographic type, such as copiers and printers, it is common to develop with toner an electrostatic latent image formed on the surface of a photosensitive drum as an image carrying member to form a toner image that will later be transferred to a sheet. The toner is supplied to a developing device by use of a container that is removably mounted in the body of the image forming apparatus.

### SUMMARY

According to one aspect of the present disclosure, an image forming apparatus includes a developing device, a container, a toner supplying device, and a control portion. The developing device supplies toner to an image carrying member. The container stores the toner supplied to the developing device. The toner supplying device transports the toner in the container to the developing device to supply the toner to it. The control portion controls the operation of the developing device and the toner supplying device. The control portion senses toner emptiness in the container by using a plurality of emptiness sensing paths and uses different emptiness sensing conditions for the plurality of emptiness sensing paths.

### BRIEF DESCRIPTION OF THE DRAWINGS

FIG. 1 is a schematic sectional view of an image forming apparatus according to one embodiment of the present disclosure.

FIG. 2 is a block diagram showing an outline of the configuration of the image forming apparatus in FIG. 1.

FIG. 3 is a sectional view around an image forming portion in the image forming apparatus in FIG. 1.

FIG. 4 is a perspective view around a toner supplying device in the image forming apparatus in FIG. 1.

FIG. 5 is a front view around the toner supplying device in FIG. 4.

FIG. 6 is a side view around the toner supplying device in FIG. 4.

FIG. 7 is a perspective view of the toner supplying device in FIG. 4.

FIG. 8 is a plan view of the toner supplying device in FIG. 4.

FIG. 9 is a perspective view of a first transport pipe and a second transport pipe in the toner supplying device in FIG. 7.

FIG. 10 is a flow chart showing an example of a procedure for a toner emptiness sensing path with respect to a developing device.

FIG. 11 is a flow chart showing an example of a procedure for a toner emptiness sensing path with respect to the toner supplying device.

FIG. 12 is a flow chart showing an example of a procedure for a toner emptiness sensing path with respect to a container.

### DETAILED DESCRIPTION

An embodiment of the present disclosure will be described below with reference to the accompanying drawings. The present disclosure, however, is not limited by the following description.

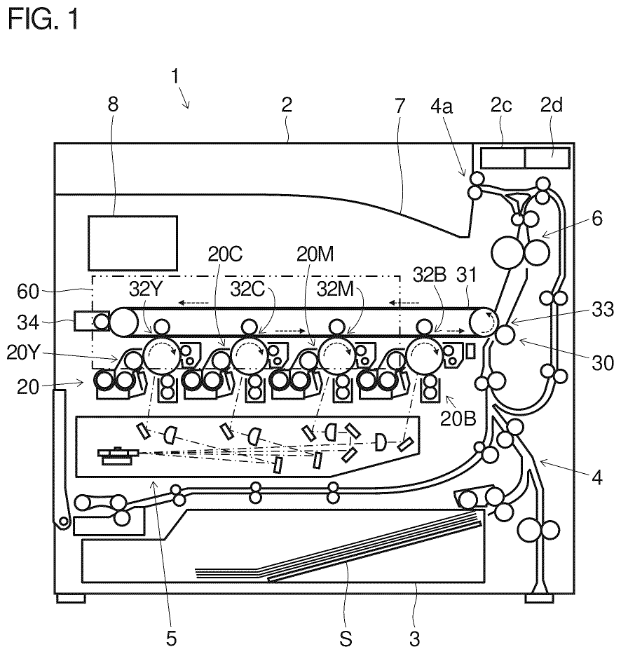

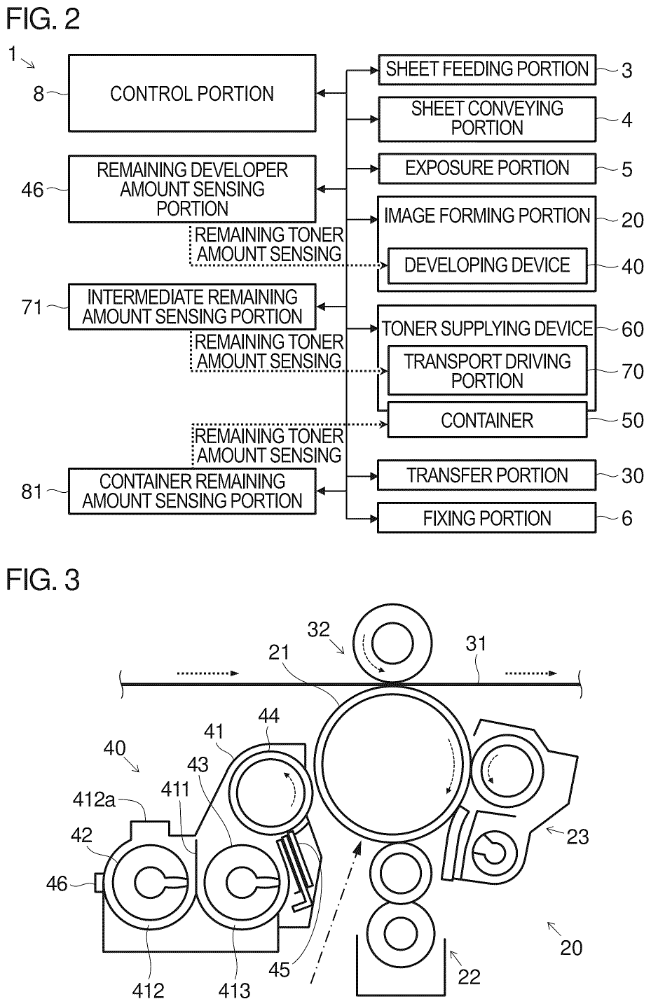

FIG. 1 is a schematic sectional view of an image forming apparatus 1 according to the embodiment. FIG. 2 is a block diagram showing an outline of the configuration of the image forming apparatus 1 in FIG. 1. FIG. 3 is a sectional view around an image forming portion 20 in the image forming apparatus 1 in FIG. 1. One example of the image forming apparatus 1 of the embodiment is a tandem-type color printer that transfers a toner image to a sheet S by use of an intermediate transfer belt 31. The image forming apparatus 1 can be what is called a multifunction peripheral that has functions of printing, scanning (image reading), facsimile transmission, and the like.

As shown in FIGS. 1, 2, and 3, the image forming apparatus 1 includes, inside its body 2, a sheet feeding portion 3, a sheet conveying portion 4, an exposure portion 5, an image forming portion 20, a transfer portion 30, a fixing portion 6, a sheet discharge portion 7, and a control portion 8.

The body 2 includes an operation panel 2c. The operation panel 2c is disposed, for example, in an upper front part of the body 2, and includes a display portion 2d such as a liquid crystal display. The operation panel 2c displays, on the display portion 2d, the images of screens for the setting of printing conditions such as the type and size of the sheet S to be used in printing and for the entry of execution instructions, and accepts input from a user in response. The display portion 2d also displays, for example, the status of the image forming apparatus 1, warnings and error messages, and the like and thus serves as a notifying portion for notifying the user of them.

The sheet feeding portion 3 is disposed in a bottom part of the body 2. The sheet feeding portion 3 stores a plurality of unprinted sheets S, and separates and feeds out one sheet S after another during printing. The sheet conveying portion 4 extends along the top-bottom direction, along a side wall of the body 2. The sheet conveying portion 4 conveys the sheet S fed out from the sheet feeding portion 3 to a secondary transfer portion 33 and then to the fixing portion 6, and then discharges the sheet S having undergone fixing through a sheet discharge port 4a to the sheet discharge portion 7. The exposure portion 5 is disposed above the sheet feeding portion 3. The exposure portion 5 shines laser light controlled based on image data to the image forming portion 20.

The image forming portion 20 is disposed above the exposure portion 5, below the intermediate transfer belt 31. The image forming portion 20 includes an image forming portion 20Y for yellow, an image forming portion for cyan 20C, an image forming portion for magenta 20M, and an image forming portion 20B for black. These four image forming portions 20 have basically the same configuration. Accordingly, in the following description, unless distinction is needed, the suffixes “Y,” “C,” “M,”, and “B” that distinguish colors will sometimes be omitted.

The image forming portion 20 includes a photosensitive drum (image carrying member) 21 that is supported so as to be rotatable in a predetermined direction (clockwise in FIGS. 1 and 3). The image forming portion 20 further includes, disposed around the photosensitive drum 21 along its rotation direction, a charging portion 22, a developing device 40, and a drum cleaning portion 23. Between the developing device 40 and the drum cleaning portion 23, a primary transfer portion 32 is disposed.

The photosensitive drum 21 is formed in the shape of a cylinder extending along a horizontal direction, and has a photosensitive layer on its outer circumferential surface. The charging portion 22 electrostatically charges the surface (outer circumferential surface) of the photosensitive drum 21 to a predetermined potential. The exposure portion 5 exposes to light the outer circumferential surface of the photosensitive drum 21 electrostatically charged by the charging portion 22 to form on the outer circumferential surface of the photosensitive drum 21 an electrostatic latent image of a document image. The developing device 40 supplies toner to this electrostatic latent image to develop it to form a toner image. The four image forming portions 20 form toner images of different colors respectively. The drum cleaning portion 23 performs cleaning by removing the toner and the like that are left on the outer circumferential surface of the photosensitive drum 21 after the primary transfer of the toner images to the outer circumferential surface of the intermediate transfer belt 31. In this way the image forming portion 20 forms the image (toner image) that will later be transferred to the sheet S.

The transfer portion 30 includes the intermediate transfer belt 31, primary transfer portions 32Y, 32C, 32M, and 32B, the secondary transfer portion 33, and a belt cleaning portion 34. The intermediate transfer belt 31 is disposed above the four image forming portions 20. The intermediate transfer belt 31 is an endless intermediate transfer member that is supported so as to be rotatable in a predetermined direction (counter-clockwise in FIG. 1) and to which the toner images formed by the four image forming portions 20 are primarily transferred sequentially so as to be overlaid on each other. The four image forming portions 20 are disposed in what is called a tandem arrangement in which they are arrayed in a row from upstream to downstream in the rotation direction of the intermediate transfer belt 31.

The primary transfer portions 32Y, 32C, 32M, and 32B are disposed, across the intermediate transfer belt 31, above the image forming portions 20Y, 20C, 20M, and 20B of the corresponding colors. The secondary transfer portion 33 is disposed upstream of the fixing portion 6 with respect to the sheet conveyance direction of the sheet conveying portion 4, downstream of the four image forming portions 20Y, 20C, 20M, and 20B with respect to the rotation direction of the intermediate transfer belt 31. The belt cleaning portion 34 is disposed downstream of the secondary transfer portion 33 with respect to the rotation direction of the intermediate transfer belt 31.

The primary transfer portion 32 transfers the toner image formed on the outer circumferential surface of the photosensitive drum 21 to the intermediate transfer belt 31. The In other words, the toner images are, in the primary transfer portions 32Y, 32C, 32M, and 32B of the corresponding colors, primarily transferred to the outer circumferential surface of the intermediate transfer belt 31. Then, as the intermediate transfer belt 31 rotates, the toner images from the four image forming portions 20 are transferred to the intermediate transfer belt 31 sequentially with predetermined timing so as to be overlaid on each other, so that a color toner image having the toner images of four colors, namely yellow, cyan, magenta, and black, overlaid on each other is formed on the outer circumferential surface of the intermediate transfer belt 31.

The color toner image on the outer circumferential surface of the intermediate transfer belt 31 is transferred, at a secondary transfer nip formed in the secondary transfer portion 33, to a sheet S conveyed by the sheet conveying portion 4 in synchronization. The belt cleaning portion 34 performs cleaning by removing the deposit such as toner that is left on the outer circumferential surface of the intermediate transfer belt 31 after secondary transfer. In this way the transfer portion 30 transfers (records) the toner image formed on the outer circumferential surface of the photosensitive drum 21 to the sheet.

The fixing portion 6 is disposed above the secondary transfer portion 33. The fixing portion 6 heats and presses the sheet S having the toner image formed on it to fix the toner image to the sheet S.

The sheet discharge portion 7 is disposed above the transfer portion 30. The sheet S having the toner image fixed to and thus having undergone printing is conveyed to the sheet discharge portion 7. The sheet discharge portion 7 permits the printed sheet (printed matter) to be retrieved upward.

The control portion 8 includes a CPU, an image processor, a storage, and other electronic circuits and electronic components (none is shown). Based on programs and data for control stored in the storage, the CPU controls the operation of the components of the image forming apparatus 1 to perform processes for carrying out the functions of the image forming apparatus 1. The sheet feeding portion 3, the sheet conveying portion 4, the exposure portion 5, the image forming portion 20, the transfer portion 30, and the fixing portion 6 individually receive instructions from the control portion 8 and cooperate to perform printing on the sheet S. The storage is composed of, for example, a combination of a non-volatile storage device, such as a program ROM (read-only memory) and a data ROM, and a volatile memory device, such as a RAM (random-access memory).

Next, the construction of and around the developing device 40 will be described with reference to FIG. 3. The developing devices 40 of the different colors have basically the same configuration; accordingly, for their components, the suffixes distinguishing colors will be omitted and no overlapping description will be repeated.

The developing device 40 supplies toner to the outer circumferential surface of the photosensitive drum 21. The developing device 40 includes a developer container 41, a first stirring-transporting member 42, a second stirring-transporting member 43, a developing roller 44, a regulating member 45, and a toner concentration sensor (remaining developer amount sensing portion) 46.

The developer container 41 has an elongate shape extending along the axial direction of the photosensitive drum 21 (the direction from the near to the far side of the plane of FIG. 3), and is disposed with its longitudinal direction aligned horizontally. The developer container 41 stores, as developer containing toner to be supplied to the photosensitive drum 21, two-component developer containing toner and magnetic carrier. The developer container 41 has a partition 411, a first transport chamber 412, and a second transport chamber 413.

The partition 411 is provided in a lower part inside the developer container 41. The partition 411 is disposed substantially in a middle part of the lower part of the developer container 41 with respect to a direction (horizontally left-right direction in FIG. 3) crossing the axial direction, and extends in the axial and top-bottom directions. The partition 411 divides the interior of the developer container 41 with respect to the direction (left-right direction in FIG. 3) crossing the axial direction. The developer container 41 has, at each end of the partition 411 along the axial direction (direction from the near to the far side of the plane of FIG. 3), a communication portion (not shown) between the first and second transport chambers 412 and 413.

The first and second transport chambers 412 and 413 are provided inside the developer container 41. The first and second transport chambers 412 and 413 are formed as a result of the interior of the developer container 41 being divided by the partition 411, and lie side by side. The second transport chamber 413 is disposed inside the developer container 41, adjacently below the region where the developing roller 44 is disposed. The first transport chamber 412 is disposed inside the developer container 41, in a region farther from the developing roller 44 than the second transport chamber 413 is. The first transport chamber 412 is fed with developer through a supply pipe connection portion 412a shown in FIG. 3.

The first stirring-transporting member 42 is disposed inside the first transport chamber 412. The second stirring-transporting member 43 is disposed inside the second transport chamber 413. The second stirring-transporting member 43 lies close to and extends parallel to the developing roller 44. The first and second stirring-transporting members 42 and 43 are supported on the developer container 41 so as to be rotatable about axes extending parallel to the photosensitive drum 21. The first and second stirring-transporting members 42 and 43 rotate about their axes to transport, while stirring, the developer in opposite directions along the axial directions of their rotation.

As the first and second stirring-transporting members 42 and 43 rotate, developer circulates between the first and second transport chambers 412 and 413 through the communication portion disposed at each of opposite end parts of the partition 411 along the axial direction. In the first and second transport chambers 412 and 413, toner supplied from outside is stirred to be electrostatically charged.

The developing roller 44 is located inside the developer container 41, above the second stirring-transporting member 43, and is disposed opposite the photosensitive drum 21. The developing roller 44 is supported on the developer container 41 so as to be rotatable about an axis extending parallel to the axis of the photosensitive drum 21.

Part of the outer circumferential surface of the developing roller 44 is exposed through the developer container 41 to face and lie close to the photosensitive drum 21. In a region where it faces the photosensitive drum 21, the developing roller 44 carries on its outer circumferential surface the toner to be supplied to the outer circumferential surface of the photosensitive drum 21. The developing roller 44 attaches the toner inside the second transport chamber 413 to the electrostatic latent image on the outer circumferential surface of the photosensitive drum 21 to form the toner image.

The regulating member 45 is disposed upstream, in the rotation direction of the developing roller 44, of the region where the developing roller 44 and the photosensitive drum 21 face each other. The regulating member 45 lies close to and faces the developing roller 44, and is disposed with a predetermined interval between the tip end of the regulating member 45 and the outer circumferential surface of the developing roller 44. The regulating member 45 extends over the entire dimension of the developing roller 44 along its axial direction (direction from the near to the far side of the plane of FIG. 3). The regulating member 45 regulates the layer thickness of the developer (toner) carried on the outer circumferential surface of the developing roller 44 that passes through the gap between the tip end of the regulating member 45 and the outer circumferential surface of the developing roller 44.

The toner concentration sensor 46 is disposed on a wall part of the first transport chamber 412 along its longitudinal direction. The toner concentration sensor 46 is disposed opposite the first stirring-transporting member 42. In the embodiment, used as the toner concentration sensor 46 is a headless sensor. The headless sensor used as the toner concentration sensor 46 has its sensing face buried in the inner wall surface of the first transport chamber 412. The toner concentration sensor 46 senses the concentration of the toner in the developer.

More specifically, the toner concentration sensor 46 is a sensor of a magnetic permeability sensing type that senses the change of the magnetic permeability of two-component developer and thereby determines toner concentration (the mixing ratio of toner T to carrier C in developer, i.e., T/C). As the ratio of toner to carrier in the developer in the first transport chamber 412 changes, the magnetic permeability changes and the out signal of the toner concentration sensor 46 changes accordingly.

In connection with a toner emptiness sensing path with respect to the developing device 40, the control portion 8 controls the starting and stopping of the supply of developer (toner and carrier) to the developing device 40 based on a sensor output signal received from the toner concentration sensor 46. That is, the toner concentration sensor 46 is a remaining developer amount sensing portion that senses the toner concentration in the developing device 40 and thereby senses the amount of remaining toner, and is thus a remaining toner amount sensing portion. This constitutes a toner emptiness sensing path with respect to the developing device 40 in terms of control.

The toner in the developer container 41 is electrostatically charged by being stirred and circulated by the first and second stirring-transporting members 42 and 43, and is carried on the outer circumferential surface of the developing roller 44 by the second stirring-transporting member 43. The developer carried on the outer circumferential surface of the developing roller 44 has its layer thickness regulated by the regulating member 45 and is then transported, as the developing roller 44 rotates, to the region where the developing roller 44 and the photosensitive drum 21 face each other. When a predetermined developing voltage is applied to the developing roller 44, the potential difference between it and the potential on the surface (outer circumferential surface) of the photosensitive drum 21 causes the toner in the developer carried on the outer circumferential surface of the developing roller 44 to move, in the face-to-face region, to the outer circumferential surface of the photosensitive drum 21. Thus the electrostatic latent image on the outer circumferential surface of the photosensitive drum 21 is developed with the toner.

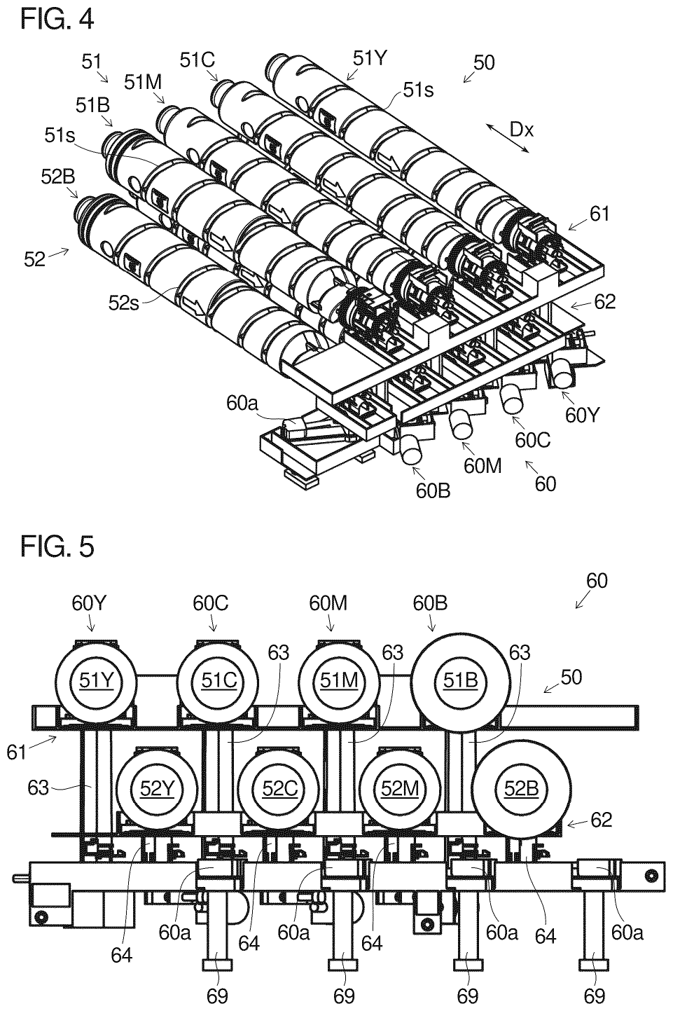

For the supply of toner to the developing device 40, the image forming apparatus 1 includes a container 50 and a toner supplying device 60 (see FIG. 4). The container 50 includes a first container 51 and a second container 52. The image forming apparatus 1 has a plurality of containers 50 (first and second containers 51 and 52) that store toner of the same color. In the following description, the first and second containers 51 and 52 are occasionally referred to collectively as the “container 50.”

The first container 51, the second container 52, and the toner supplying device 60 are disposed above the developing device 40. The first container 51, the second container 52, and the toner supplying device 60 are provided one each for each of the four colors of yellow, cyan, magenta, and black.

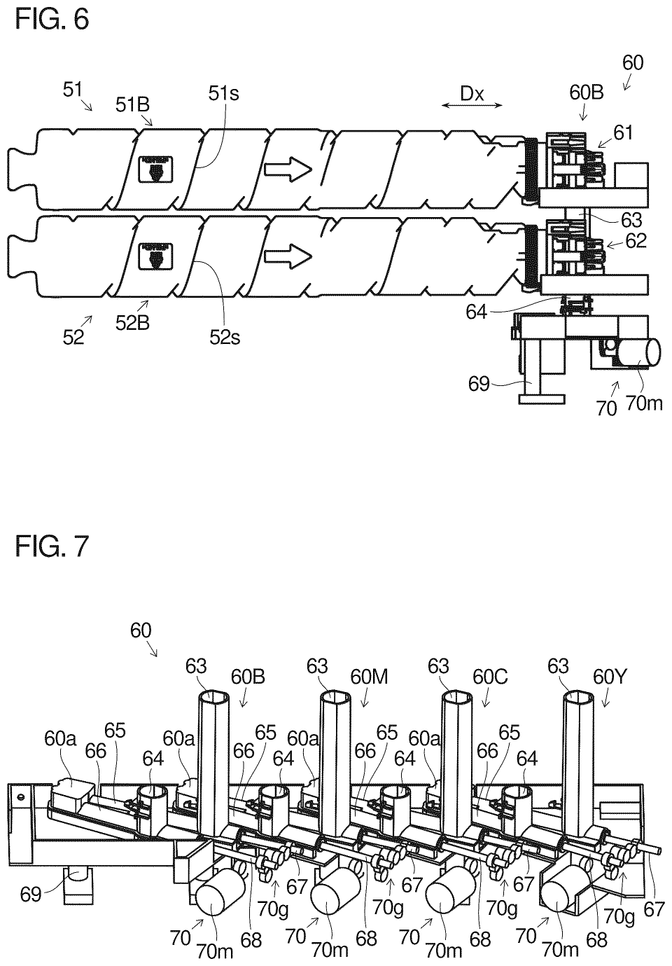

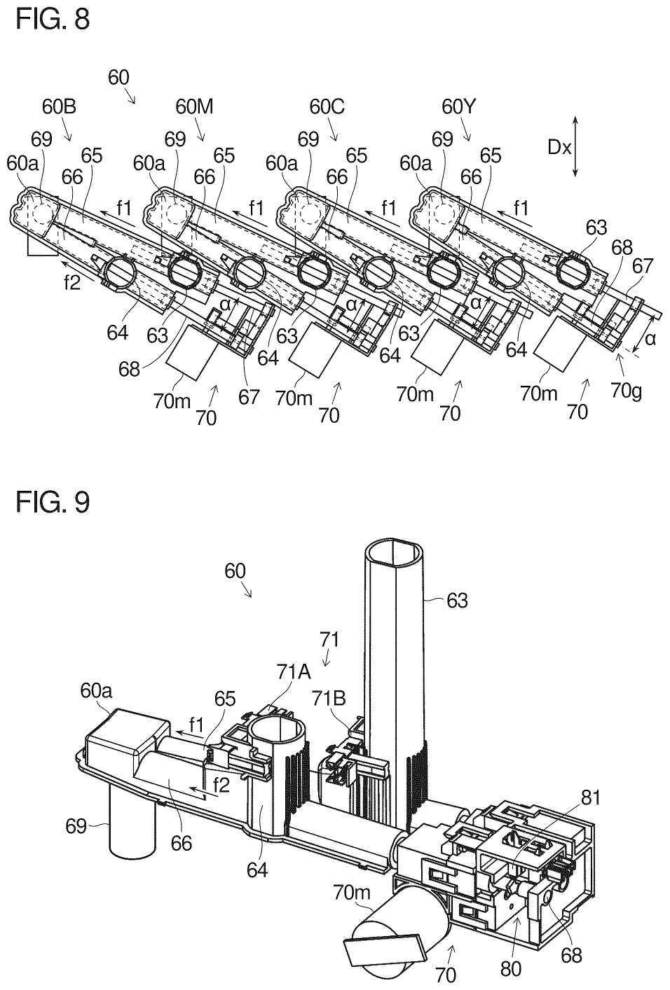

Next, the configuration of the container 50 and the toner supplying device 60 will be described with reference to FIGS. 4 to 9. FIG. 4 is a perspective view around the toner supplying device 60 in the image forming apparatus 1 in FIG. 1. FIGS. 5 and 6 are a front view and a side view, respectively, around the toner supplying device 60 in FIG. 4. FIGS. 7 and 8 are perspective view and a plan view, respectively, of the toner supplying device 60 in FIG. 4. FIG. 9 is a perspective view of a first transport pipe 65 and a second transport pipe 66 in the toner supplying device 60 in FIG. 7.

The first container 51, the second container 52, and the toner supplying device 60 include a first container 51Y, a second container 52Y, and a toner supplying device 60Y for yellow, a first container 51C, a second container 52C, and a toner supplying device 60C for cyan, a first container 51M, a second container 52M, and a toner supplying device 60M for magenta, and a first container 51K, a second container 52K, and a toner supplying device 60K for black. The first containers 51, the second containers 52, and the toner supplying devices 60 for the different colors have basically the same configurations. Accordingly, in the following description, unless distinction is needed, the suffixes “Y,” “C,” “M,”, and “B” that distinguish colors will sometimes be omitted.

The first container 51 is disposed above the second container 52. The second container 52 is disposed below the first container 51. The first and second containers 51 and 52 are disposed, as seen from in front, displaced from each other in the array direction of the image forming portions 20 and the toner supplying devices 60. The first and second containers 51 and 52 are removably mounted in the body 2 and store the toner supplied to the developing device 40.

The first and second containers 51 and 52 are each in the shape of an elongate cylinder extending along the axial direction Fx of the photosensitive drum 21, and are disposed with their longitudinal direction aligned horizontally. On the circumferential walls of the first and second containers 51 and 52, protrusions 51s and 52s are formed that protrude inward in the radial direction and that extend spirally in the longitudinal direction.

The first and second containers 51 and 52 are closed at one end (front side) along the axial direction Dx and have an opening (not shown) at the other end (rear side). The first and second containers 51 and 52 are at their rear side, that is, open end, connected to the first and second containers 51 and 52 of the toner supplying device 60. The first and second containers 51 and 52 are supported on the toner supplying device 60 so as to be rotatable about axes extending parallel to the axial direction Dx of the photosensitive drum 21.

The first and second containers 51 and 52 are rotated about axes extending parallel to the axial direction Dx of the photosensitive drum 21 by a driving portion (not shown) in the toner supplying device 60. As the first and second containers 51 and 52 rotate, the toner inside is fed by the protrusions 51s and 52s toward the rear side, that is, open end. As a result, the toner in the first and second containers 51 and 52 move through the openings into the toner supplying device 60.

The toner supplying device 60 are disposed at the rear of the first and second containers 51 and 52. The four toner supplying devices 60 are arrayed in a row in the same order as the four image forming portions 20. The toner supplying device 60 rotates the first and second containers 51 and 52 to supply the toner in the first and second containers 51 and 52 to the developing device 40.

The toner supplying device 60 includes a first container connection portion 61, a second container connection portion 62, a first vertical pipe 63, a second vertical pipe 64, the first transport pipe 65, the second transport pipe 66, a first transport member 67, a second transport member 68, a supply pipe 69, a transport driving portion 70, an intermediate remaining amount sensing portion 71, and a rotation sensing portion 80.

The first container connection portion 61 is disposed in an upper part of the toner supplying device 60, above the second container connection portion 62. The first container connection portion 61 has inside it a toner circulation passage (not shown). To the first container connecting portion 61, the first container 51 is connected at its open side so as to be rotatably supported. The downstream end of the first container connection portion 61 along the toner circulation direction is connected to the first vertical pipe 63. When the toner in the first container 51 is supplied to the developing device 40, the toner moves from the first container 51 into the first container connecting portion 61 and then through the first container connecting portion 61 out into the first vertical pipe 63.

The second container connection portion 62 is disposed in an upper part pf the toner supplying device 60, below the first container connecting portion 61. The second container connection portion 62 has inside it a toner circulation passage (not shown). To the second container connecting portion 62, the second container 52 is connected at its open side so as to be rotatably supported. The downstream end of the second container connection portion 62 along the toner circulation direction is connected to the second vertical pipe 64. When the toner in the second container 52 is supplied to the developing device 40, the toner moves from the second container 52 into the second container connection portion 62 and then through the second container connection portion 62 out into the second vertical pipe 64.

The first vertical pipe 63 is disposed between the first container connection portion 61 and the first transport pipe 65. The first vertical pipe 63 is formed in the shape of a pipe extending along the top-bottom direction. The upper end of the first vertical pipe 63 is connected to the first container connection portion 61. The lower end of the first vertical pipe 63 is connected to the first transport pipe 65. When the toner in the first container 51 is supplied to the developing device 40, the toner moves from the first container connection portion 61 into the first vertical pipe 63 and then through the first vertical pipe 63 out into the first transport pipe 65.

The second vertical pipe 64 is disposed between the second container connection portion 62 and the second transport pipe 66. The second vertical pipe 64 is formed in the shape of a pipe extending along the top-bottom direction. The upper end of the second vertical pipe 64 is connected to the second container connection portion 62. The lower end of the second vertical pipe 64 is connected to the second transport pipe 66. When the toner in the second container 52 is supplied to the developing device 40, the toner moves from the second container connection portion 62 into the second vertical pipe 64 and then through the second vertical pipe 64 out into the second transport pipe 66.

Owing to the first container 51 and the first container connection portion 61 being disposed above the second container 52 and the second container connection portion 62, the first vertical pipe 63 is longer than the second vertical pipe 64 along the top-bottom direction. Owing to the second container 52 and the second container connection portion 62 being disposed below the first container 51 and the first container connection portion 61, the second vertical pipe 64 is shorter than the first vertical pipe 63 along the top-bottom direction. The first and second vertical pipes 63 and 64 are disposed at the same position along the axial direction Dx of the photosensitive drum 21. In other words, the first and second vertical pipes 63 and 64 stand side by side on a straight line orthogonal to the axial direction Dx.

The first transport pipe 65 is disposed between the first vertical pipe 63 and the supply pipe 69 along the top-bottom direction. The first transport pipe 65 is formed in the shape of a pipe extending along a horizontal direction. To one end of the first transport pipe 65 along its extending direction, the first vertical pipe 63 is connected. The other end of the first transport pipe 65 along its extending direction is connected to a junction portion 60a. When the toner in the first container 51 is supplied to the developing device 40, the toner moves from the first vertical pipe 63 into the first transport pipe 65 and then through the first transport pipe 65 out into the junction portion 60a. In other words, the first transport pipe 65 is connected between the first container 51 and the supply pipe 69, and the toner is transported from the first container 51 to the supply pipe 69.

The second transport pipe 66 is disposed between the second vertical pipe 64 and the supply pipe 69 along the top-bottom direction. The second transport pipe 66 is formed in the shape of a pipe extending along a horizontal direction. To one end of the second transport pipe 66 along its extending direction, the second vertical pipe 64 is connected. The other end of the second transport pipe 66 along its extending direction is connected to the junction portion 60a. When the toner in the second container 52 is supplied to the developing device 40 the toner moves from the second vertical pipe 64 into the second transport pipe 66 and then through the second transport pipe 66 out into the junction portion 60a. In other words, the second transport pipe 66 is connected between the second container 52 and the supply pipe 69, and the toner is transported from the second container 52 to the supply pipe 69.

The first and second transport pipes 65 and 66 are arranged beside each other along a direction (horizontal direction) crossing their extending directions such that they join in the junction portion 60a, to which the supply pipe 69 connects. In other words, the first and second transport pipes 65 and 66 are disposed such that their extension lines cross each other at the side at which they are connected to the junction portion 60a along their extending directions. The first and second transport pipes 65 and 66 form between their extending directions an acute angle in a horizontal direction, and are disposed in a V-shape as seen from the top-bottom direction.

The first transport member 67 is disposed inside the first transport pipe 65. The first transport member 67 has a rotary shaft provided between its opposite ends along the axial direction of the first transport pipe 65 in the shape of a pipe and a first transport blade formed on the outer circumferential surface of the rotary shaft so as to spirally extend along the axial direction. The first transport member 67 is supported inside the first transport pipe 65 so as to be rotatable about an axis extending in a horizontal direction. One end of the first transport member 67 along the axial direction is located inside the junction portion 60a.

The first transport member 67, by rotating about its axis, transports, while stirring, the toner in the first transport pipe 65 along a toner transport direction f1 (see FIGS. 8 and 9) parallel to the rotation axis. The first transport member 67 transports the toner in the first transport pipe 65 from the first vertical pipe 63 to the junction portion 60a. In other words, the first transport member 67 transports the toner from the first container 51 to the supply pipe 69.

The second transport member 68 is disposed inside the second transport pipe 66. The second transport member 68 has a rotary shaft provided between its opposite ends along the axial direction of the second transport pipe 66 in the shape of a pipe and a second transport blade formed on the outer circumferential surface of the rotary shaft so as to spirally extend along the axial direction. The second transport member 68 is supported inside the second transport pipe 66 so as to be rotatable about an axis extending in a horizontal direction. One end of the second transport member 68 along the axial direction is located inside the junction portion 60a.

The second transport member 68, by rotating about its axis, transports, while stirring, the toner in the second transport pipe 66 along a toner transport direction f2 (see FIGS. 8 and 9) parallel to the rotation axis. The second transport member 68 transports the toner in the second transport pipe 66 from the second vertical pipe 64 to the junction portion 60a. In other words, the second transport member 68 transports the toner from the second container 52 to the supply pipe 69.

As mentioned above, the first and second transport pipes 65 and 66 are disposed in a V-shape as seen from the top-bottom direction. That is, the first and seconds transport members 68 are disposed such that their rotation axes form a predetermined axial angle a.

The supply pipe 69 is disposed in a lower part of the toner supplying device 60. The toner supplying device 60 has a single supply pipe 69. The supply pipe 69 is formed in the shape of a pipe extending along the top-bottom direction. The upper end of the supply pipe 69 is connected to the junction portion 60a, in which the first and second transport pipes 65 and 66 join. The lower end of the supply pipe 69 is connected to the supply pipe connection portion 412a of the developing device 40. When the toner in the first and second containers 51 and 52 is supplied to the developing device 40, the toner moves from the junction portion 60a to supply pipe 69 and then through the supply pipe 69 into the developing device 40.

The transport driving portion 70 is disposed in a rear part of the toner supplying device 60, upstream of the first and second transport pipes 65 and 66 in the toner transport direction. The transport driving portion 70 includes a motor 70m and a gear train 70g composed of a plurality of gears. The motor 70m is coupled via the gear train 70g to each of the first and second transport members 67 and 68. The transport driving portion 70 rotates the motor 70m either forward or backward to rotate selectively one of the first and second transport members 67 and 68.

The intermediate remaining amount sensing portion 71 includes a first intermediate remaining amount sensing portion 71A and a second intermediate remaining amount sensing portion 71B. The first intermediate remaining amount sensing portion 71A is disposed in a lower part of the first vertical pipe 63. The second intermediate remaining amount sensing portion 71B is disposed in a lower part of the second vertical pipe 64. The first and second intermediate remaining amount sensing portions 71A and 71B are configured as sensors of a magnetic permeability sensing type like the toner concentration sensor 46. The first intermediate remaining amount sensing portion 71A senses change of the magnetic permeability of the two-component developer in the lower part of the first vertical pipe 63 and outputs a sensing signal. The second intermediate remaining amount sensing portion 71B senses change of the magnetic permeability of the two-component developer in the lower part of the second vertical pipe 64 and outputs a sensing signal.

In connection with a toner emptiness sensing path with respect to the toner supplying device 60, the control portion 8 controls the starting and stopping of the supply of developer to the developing device 40 based on sensor output signals received from the first and second intermediate remaining amount sensing portions 71A and 71B. That is, the first and second intermediate remaining amount sensing portions 71A and 71B are remaining toner amount sensing portions that sense the amount of remaining toner on the toner supply path of the toner supplying device 60. This constitutes a toner emptiness sensing path with respect to the toner supplying device 60 in terms of control.

The rotation sensing portion 80 is disposed in a rear part of the toner supplying device 60, upstream of the transport driving portion 70 in the toner transport direction. The rotation sensing portion 80 includes a container remaining amount sensing portion 81 and light shield plates (not shown) that rotate individually together with the first and second transport members 67 and 68 respectively.

The container remaining amount sensing portion 81 is, for example, a transmissive optical sensor; it has a light transmitter and a light receiver and has an optical path leading from the light transmitter to the light receiver. The light shield plates are movable into and out of the optical path of the transmissive optical sensor. The container remaining amount sensing portion 81 senses the rotation of the first and second transport members 67 and 68 and outputs sensing signals.

In connection with a toner emptiness sensing path with respect to the container 50, the control portion 8 senses the amounts of toner remaining in the first and second containers 51 and 52 based on sensor output signals received from the container remaining amount sensing portion 81. Specifically, based on the output signals of the container remaining amount sensing portion 81, the control portion 8 counts the numbers of turns of the first and second transport members 67 and 68 and, based on the numbers of turns, senses the amounts of toner remaining in the first and second containers 51 and 52. That is, the container remaining amount sensing portion 81 is a remaining toner amount sensing portion that senses the amount of toner remaining in the container 50. This constitutes a toner emptiness sensing path with respect to the container 50 in terms of control.

Now, the toner emptiness sensing paths will be described. The image forming apparatus 1 has a plurality of toner emptiness sensing paths. In the embodiment, the image forming apparatus 1 has three toner emptiness sensing paths. Specifically, the control portion 8 senses toner emptiness in the container 50 using toner emptiness sensing paths with respect to three blocks, namely the developing device 40, the toner supplying device 60, and the container 50.

With this configuration, in case of a fault in any of the toner emptiness sensing paths with respect to the developing device 40, the toner supplying device 60, and the container 50, toner emptiness can be sensed in the other paths. It is thus possible, on the image forming apparatus 1, to eliminate failure to sense toner emptiness and continue proper supply of toner. The control for the three toner emptiness sensing paths is run concurrently.

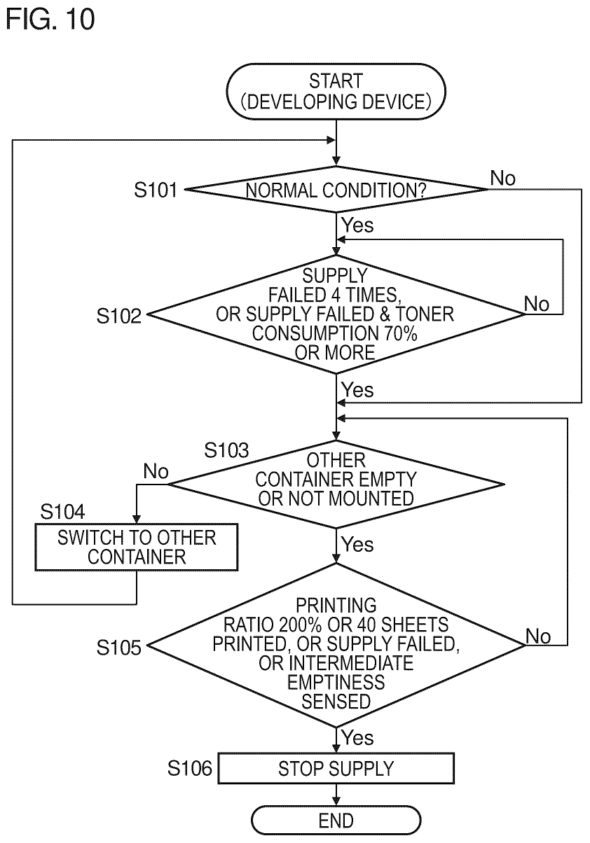

Next, a procedure for the toner emptiness sensing path with respect to the developing device 40 will be described. FIG. 10 is a flow chart showing an example of the procedure for the toner emptiness sensing path with respect to the developing device 40.

When the image forming apparatus 1 starts operating, toner condition starts to be monitored in the toner emptiness sensing path with respect to the developing device 40 (“START” in FIG. 10). The control portion 8 then checks whether the developing device 40 is in normal condition (Step S101). If the developing device 40 is in normal condition (Step S101, Yes), an advance is made to Step S102; if the developing device 40 is not in normal condition (Step S101, No), an advance is made to Step S103.

The control portion 8 checks, with respect to the developing device 40, whether forced supply of toner has failed four times, or whether forced supply of toner has failed and in addition toner consumption is 70% or more (Step S102). If either of the conditions is fulfilled (Step S102, Yes), an advance is made to Step S103; if neither of the conditions is fulfilled (Step S102, No), the check at Step S102 is done again.

Here, forced supply of toner on the developing device 40 will be described. On the developing device 40, forced supply of toner is performed when the toner concentration (the mixing ratio of toner T to carrier C in developer, i.e., T/C) as sensed by the toner concentration sensor (remaining developer amount sensing portion) 46 becomes 2% lower than the target. If forced supply of toner succeeds, the control portion 8 brings the developing device 40 back to normal condition. Even if forced supply of toner fails, unless the toner concentration has not become 2% lower than the target, the control portion 8 performs forced supply of toner when the toner concentration becomes 2% lower than the target.

If the developing device 40 enters warm-up operation in low-toner condition (condition where the amount of remaining toner is under a predetermined value), during the warm-up operation the control portion 8 performs forced supply of toner. On the developing device 40, forced supply of toner may be interrupted when the exterior cover (not shown) of the image forming apparatus 1 is opened and closed. In that case, when the cover is closed, forced supply is restarted. On the developing device 40, the number of times that forced supply of toner has been performed is stored in a storage or the like so as to be retained even when the power to the image forming apparatus 1 is turned off.

On the developing device 40, if forced supply of toner has failed four times or if forced supply of toner fails and in addition toner consumption is 70% or more, the control portion 8 checks whether, with respect to one container 50 in use out of the first and second containers 51 and 52 storing toner of the same color, the other container 50 is empty or is not mounted in the image forming apparatus 1 (Step S103).

On advancing to Step S103, the control portion 8 indicates on the display portion 2d on the body 2 a warning or message such as “toner low” or “shake the container.”

If, with respect to the container 50 in use, the other container 50 is not empty or is mounted (Step S103, No), the control portion 8 switches the toner supply path to the other container 50 (Step S104). That is, on sensing toner emptiness in the container 50 in use, the control portion 8 switches the toner supply path to the other container 50 of the same color. This permits smooth supply of toner.

When switching the toner supply path to the other container 50, if before that the intermediate remaining amount sensing portion 71 has sensed toner emptiness, the control portion 8 starts supplying toner to the toner supplying device 60. When switching the toner supply path to the other container 50, if before that the developing device 40 is in low-toner condition, the control portion 8 starts forced supply of toner to the developing device 40. On switching the toner supply path to the other container 50, the control portion 8 clears the number of times that forced supply of toner has been performed that is stored in the storage or the like.

If, with respect to the container 50 in use, the other container 50 is empty or is not mounted (Step S103, Yes), the control portion 8 checks whether either the printing ratio is 200% or 40 sheets have been printed, or whether forced supply of toner has failed, or whether the intermediate remaining amount sensing portion 71 has sensed toner emptiness (Step S105). If any of those conditions is fulfilled (Step S105, Yes), an advance is made to Step S106; if none of those conditions is fulfilled (Step S105, No), the check at Step S103 is done again.

If any of the conditions at Step S105 is fulfilled, the control portion 8 recognizes toner emptiness and stops supplying toner from the container 50 to the developing device 40 (Step S106). The control portion 8 then ends the procedure in FIG. 10.

On advancing to Step S106, the control portion 8 indicates on the display portion 2d on the body 2 a warning or message such as “toner empty; machine stopped” or “replace the container.”

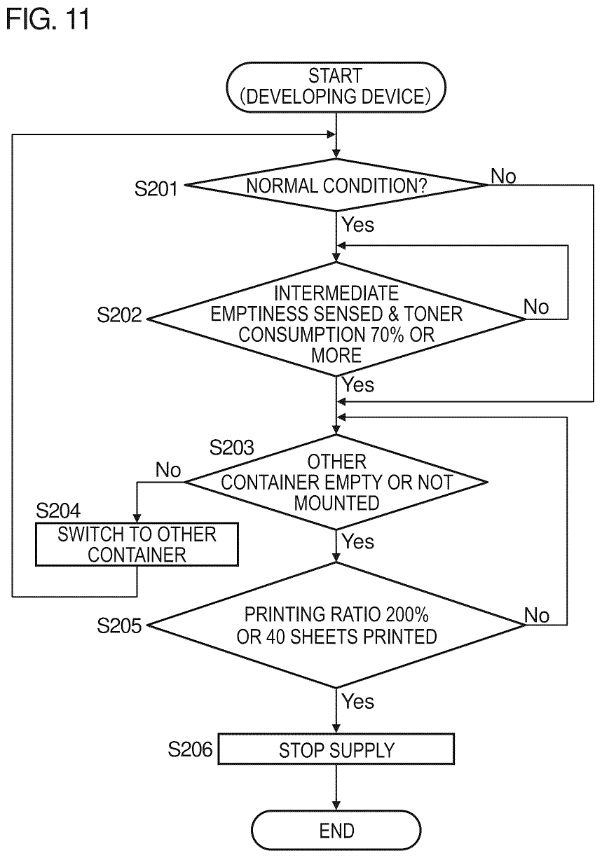

Next, a procedure for the toner emptiness sensing path with respect to the toner supplying device 60 will be described. FIG. 11 is a flow chart of the procedure for the toner emptiness sensing path with respect to the toner supplying device 60.

When the image forming apparatus 1 starts operating, toner condition starts to be monitored in the toner emptiness sensing path with respect to the toner supplying device 60 (FIG. 11, “START”). The control portion 8 then checks whether the toner supplying device 60 is in normal condition (Step S201). If the toner supplying device 60 is in normal condition (Step S201, Yes), an advance is made to Step S202; if the toner supplying device 60 is not in normal condition (Step S201, No), an advance is made to Step S203.

The control portion 8 checks, with respect to the toner supplying device 60, whether the intermediate remaining amount sensing portion 71 has sensed toner emptiness and in addition toner consumption is 70% or more (Step S202). If those conditions are fulfilled (Step S202, Yes), an advance is made to Step S203; if those conditions are not fulfilled (Step S202, No), the check at Step S202 is done again.

If, with respect to the toner supplying device 60, the intermediate remaining amount sensing portion 71 has sensed toner emptiness and in addition toner consumption is 70% or more, the control portion 8 checks, with respect to the container 50 in use out of the first and second containers 51 and 52 storing toner of the same color, the other container 50 is empty or is not mounted in the image forming apparatus 1 (Step S203).

On advancing to Step S203, the control portion 8 indicates on the display portion 2d on the body 2 a warning or message such as “toner low” or “shake the container.”

If, with respect to the container 50 in use, the other container 50 is not empty or is mounted (Step S203, No), the control portion 8 switches the toner supply path to the other container 50 (Step S204). That is, on sensing toner emptiness in the container 50 in use, the control portion 8 switches the toner supply path to the other container 50 of the same color. This permits smooth supply of toner.

When switching the toner supply path to the other container 50, if before that the intermediate remaining amount sensing portion 71 has sensed toner emptiness, the control portion 8 starts supplying toner to the toner supplying device 60. If as a result of the switching of the toner supply path to the other container 50, the intermediate remaining amount sensing portion 71 senses toner fullness, the control portion 8 brings the toner supplying device 60 back to normal condition.

If, with respect to the container 50 in use, the other container 50 is empty or is not mounted (Step S203, Yes), the control portion 8 checks whether either the printing ratio is 200% or 40 sheets have been printed (Step S205). If the condition is fulfilled (Step S205, Yes), an advance is made to Step S206; if the condition is not fulfilled (Step S205, No), the check at Step S203 is done again.

If the condition at Step S205 is fulfilled, the control portion 8 recognizes toner emptiness and stops supplying toner from the container 50 to the developing device 40 (Step S206). The control portion 8 then ends the procedure in FIG. 11.

On advancing to Step S206, the control portion 8 indicates on the display portion 2d on the body 2 a warning or message such as “toner empty; machine stopped” or “replace the container.”

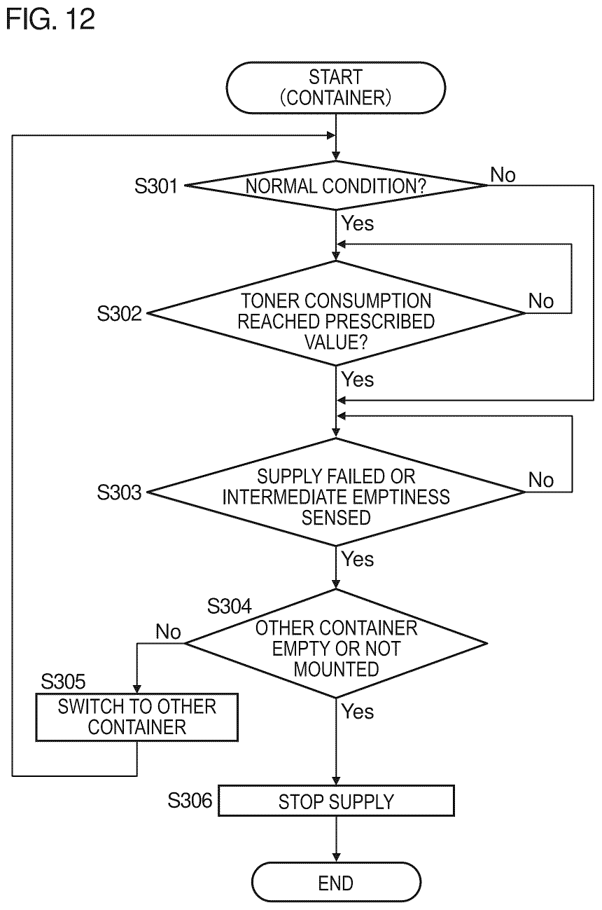

Next, a procedure for the toner emptiness sensing path with respect to the container 50 will be described. FIG. 12 is a flow chart of the procedure for the toner emptiness sensing path with respect to the container 50.

When the image forming apparatus 1 starts operating, toner condition starts to be monitored in the toner emptiness sensing path with respect to the container 50 (FIG. 12, “START”). The control portion 8 then checks whether the container 50 is in normal condition (S301). If the container 50 is in normal condition (Step S301, Yes), an advance is made to Step S302; if the container 50 is not in normal condition (Step S301, No), an advance is made to Step S303.

The control portion 8 checks, with respect to the container 50, toner consumption has reached a prescribed value (Step S302). If toner consumption has reached the prescribed value (Step S302, Yes), an advance is made to Step S303; if toner consumption has not reached the prescribed value (Step S302, No), the check at Step S302 is done again.

If, with respect to the container 50, toner consumption has reached the prescribed value, the control portion 8 checks whether forced supply of toner to the developing device 40 has failed or whether the intermediate remaining amount sensing portion 71 has sensed toner emptiness (Step S303). If either of the conditions is fulfilled (Step S303, Yes), an advance is made to Step S304; if neither of the condition is fulfilled (Step S303, No), the check at Step S303 is done again.

On advancing to Step S303, the control portion 8 indicates on the display portion 2d on the body 2 a warning or message such as “toner low” or “shake the container.”

If forced supply of toner to the developing device 40 has failed or if the intermediate remaining amount sensing portion 71 has sensed toner emptiness, the control portion 8 checks whether, with respect to the container 50 in use out of the first and second containers 51 and 52 storing toner of the same color, the other container 50 is empty or is not mounted in the image forming apparatus 1 (Step S304).

If, with respect to the container 50 in use, the other container 50 is not empty or is mounted (Step S304, No), the control portion 8 switches the toner supply path to the other container 50 (Step S305). That is, on sensing toner emptiness in the container 50 in use, the control portion 8 switches the toner supply path to the other container 50 of the same color. This permits smooth supply of toner.

When switching the toner supply path to the other container 50, if before that the intermediate remaining amount sensing portion 71 has sensed toner emptiness, the control portion 8 starts supplying toner to the toner supplying device 60. When switching the toner supply path to the other container 50, if before that the developing device 40 is in low-toner condition, the control portion 8 starts forced supply of toner to the developing device 40. On switching the toner supply path to the other container 50, the control portion 8 clears the number of times that forced supply of toner has been performed that is stored in the storage or the like.

If as a result of the switching of the toner supply path to the other container 50, the exterior cover of the image forming apparatus 1 is opened and closed and the toner consumption in the container 50 becomes less than the prescribed value, the control portion 8 brings the toner supplying device 60 back to normal condition. If the other container 50 to which the toner supply path has been switched has no tag, or if the other container 50 is a non-genuine container, the control portion 8 brings the container 50 back to normal condition.

On the other hand, if with respect to the container 50 in use, the other container 50 is empty or is not mounted (Step S304, Yes), the control portion 8 recognizes toner emptiness and stops supplying toner from the container 50 to the developing device 40 (Step S306). The control portion 8 then ends the procedure in FIG. 12.

On advancing to Step S306, the control portion 8 indicates on the display portion 2d on the body 2 a warning or message such as “toner empty; machine stopped” or “replace the container.”

As described above, the control portion 8 senses toner emptiness in the container 50 by using toner emptiness sensing paths with respect to three blocks, namely the developing device 40, the toner supplying device 60, and the container 50, and uses different sensing conditions for those three emptiness sensing paths. It is thus possible to perform toner emptiness sensing that suits the characteristics of each of the developing device 40, the toner supplying device 60, and the container 50. That is, it is possible to perform emptiness sensing for the toner in the container 50 suitably in those three emptiness sensing paths. This helps achieve appropriate toner supply on the image forming apparatus 1 and helps enhance productivity in image formation.

If toner emptiness is sensed in at least one of the three toner emptiness sensing paths with respect to the developing device 40, the toner supplying device 60, and the container 50, toner emptiness is recognized. With this configuration, when toner emptiness is sensed in any of the three toner emptiness sensing paths, the image forming apparatus 1 immediately recognizes toner emptiness. This helps enhance the effect of eliminating failure to sense toner emptiness.

The control portion 8 recognizes toner emptiness on sensing toner emptiness in a plurality of toner emptiness sensing paths. This configuration helps enhance the accuracy of toner emptiness sensing. It is thus possible to eliminate failure to sense toner emptiness and to continue appropriate supply of toner.

While an embodiment of the present disclosure has been described above, it is not meant to limit the scope of the present disclosure, which can thus be implemented with various modifications made without departure from the spirit of the present disclosure.

For example, while the above embodiment deals with a tandem-type color-printing image forming apparatus 1 that forms images of a plurality of colors sequentially while overlaying them on each other, this is not meant as any limitation to particular models. The image forming apparatus can instead be a color-printing image forming apparatus of other than a tandem type or a monochrome-printing image forming apparatus.

What is claimed is:

1. An image forming apparatus comprising:
a developing device that supplies toner to an image carrying member;
a container that stores the toner supplied to the developing device;
a toner supplying device that transports the toner in the container to the developing device to supply the toner thereto; and
a control portion that controls operation of the developing device and the toner supplying device,
wherein
the control portion senses toner emptiness in the container by using a plurality of emptiness sensing paths and uses different emptiness sensing conditions for the plurality of emptiness sensing paths.

2. The image forming apparatus according to claim 1, wherein
the image forming apparatus has at least three of the emptiness sensing paths.

3. The image forming apparatus according to claim 1, comprising:
a plurality of the containers storing the toner of a same color,
wherein
on sensing toner emptiness in one of the containers in use, the control portion switches a toner supply path to another of the containers of the same color.

4. The image forming apparatus according to claim 1, wherein
the control portion recognizes toner emptiness on sensing toner emptiness in at least one of the plurality of emptiness sensing paths.

5. The image forming apparatus according to claim 4, wherein
the control portion recognizes toner emptiness on sensing toner emptiness in the plurality of emptiness sensing paths.

6. The image forming apparatus according to claim 1, further comprising:
a remaining toner amount sensing portion disposed at a plurality of places in the container, the toner supplying device, and the developing device, the remaining toner amount sensing portion sensing an amount of remaining toner,
wherein
based on a result of sensing by the remaining toner amount sensing portion, the control portion senses toner emptiness in the container by using the plurality of emptiness sensing paths.

7. The image forming apparatus according to claim 6, wherein
the remaining toner amount sensing portion is disposed in each of the container, the toner supplying device, and the developing device.

8. The image forming apparatus according to claim 6, wherein
the remaining toner amount sensing portion includes a remaining developer amount sensing portion that senses the amount of remaining toner by sensing a toner concentration in the developing device.

9. The image forming apparatus according to claim 6, wherein
the remaining toner amount sensing portion includes an intermediate remaining amount sensing portion that senses the amount of remaining toner on a toner supply path of the toner supplying device.

10. The image forming apparatus according to claim 6, wherein
the remaining toner amount sensing portion includes a container remaining amount sensing portion that senses the amount of remaining toner in the container.
